(19) United States
(12) Patent Application Publication
(10) Pub. No.: US 2004/0201572 A1
(43) Pub. Date: Oct. 14, 2004

(54) Controlling device for mouse

(76) Inventor: Meng-Yu Wei, Taipei (TW)

Correspondence Address: SHOEMAKER AND MATTARE, LTD, 10 POST OFFICE ROAD - SUITE 110, SILVER SPRING, MD, 20910, US

(21) Appl. No.: 09/876,127

(22) Filed: Jun. 8, 2001

(30) Foreign Application Priority Data
Jun. 9, 2000 (TW) 089209939

(51) Int. Cl. G09G 5/08

(52) U.S. Cl. 345/163

(57) ABSTRACT

A controlling device for a mouse includes an input module, a switching module and a micro-controller module. First, the input module generates input signals from the input, that is, when the mouse is moved by a user, the switching module determines the current controlling state of the mouse to be operating in the XY-axes direction or the Z-axis direction, allowing the micro-controller module to activate the mouse operation from the XY-axes direction to the Z-axis direction, so as to make the mouse scroll data shown on the screen upwardly or downwardly according to the moving direction of the mouse being manipulated. In condition of no increase in assembling members and requirement of a third pair of encoders, specific driving programs or programmable integrated circuit structures, the application of a conventional mouse micro-controller and a switch is effective to proceed the scrolling operation of the mouse.

### FIELD OF THE INVENTION

The present invention relates to controlling devices for mice, and more particularly, to a controlling device for a mouse which reduces the manufacture cost thereof.

### BACKGROUND OF THE INVENTION

A mouse is an essential peripheral device of a computer system running on a graphic-based operating system. When viewing data more than a screen display range, a mouse with a scroll wheel is applied for conveniently scrolling the data up or down simply by rolling the scroll wheel. The scroll wheel partially protruding at a position of a middle key of a conventional mouse is provided with a set of optical decoders, which consist of photo-transistors and light emitting diodes, and are used to determine the magnitude of the scroll wheel being rolled.

In the foregoing mouse, the scroll wheel installed therein acts as an input signal for a functional key. Scrolling function of the mouse is then achieved by the cooperation of the input signal, and a specific driving program or programmable integrated circuit (IC) firmware structure. However, the installation of the scroll wheel and the associated third pair of optical decoders increases assembling members required for the mouse, so as to increase the production cost and the complexity of the assemblage thereof. Moreover, the scroll wheel is disposed at the middle key of the mouse, with a micro-switch provided underneath the scroll wheel, allowing to proceed functions of the middle key when pressing the scroll wheel downwardly; however, the scroll wheel is easily being rolled as being pressed, and thus it is hard to determine whether the middle key or the scroll wheel is to be functioned. In addition, the driving programs specifically used in the mouse have low compatibility with each other, and the programmable IC firmware structure is costly in manufacture, so that the mouse with the scroll wheel is further increased in the production cost thereof.

### SUMMARY OF THE INVENTION

It is therefore an objective of the present invention to provide a controlling device for a mouse which only requires a continuous switch coupling with a micro-controller of a conventional mouse, which eliminates the need for a third pair of optical decoders.

It is another objective of the invention to provide a controlling device for a mouse which requires no scroll wheel assembling member.

It is still another objective of the invention to provide a controlling device for a mouse which simplifies the assemblage of the mouse and reduces the production cost thereof.

In accordance with the foregoing and other objectives of the invention, a controlling device for a mouse is proposed. The controlling device for the mouse uses a circuit hardware, wherein input signals are directed by pressing a switch mounted therein, and transmitted to a micro-controller of a conventional mouse and analyzed thereby to produce an operating signal; the operating signal is then transmitted to a computer by a connecting interface module, allowing the computer to recognize the operating control of the mouse as scrolling upwardly or downwardly, or moving in the up-down or left-right direction.

The foregoing controlling device for the mouse includes an input module, a micro-controller module, and a switching module. The input module is activated by an input signal generated by moving the mouse. The micro-controller module analyzes the input signal and generates operating signals, which determines a controlling state of the mouse to be scrolling upwardly or downwardly, or moving in the up-down or left-right direction. The switching module then switches the mouse to operating in the XY-axes direction (i.e. in the moving state) or in the Z-axis direction (i.e. in the scrolling state) according to the operating signal.

In controlling the cursor of the mouse, first, the micro-controller module receives the current state of the switch mounted in the mouse, that is, when an user presses the switch, the micro-controller module operates on the controlling of the mouse to be in the Z-axis direction, allowing the mouse to scroll data shown on the screen upwardly or downwardly according to the moving direction of the mouse handled by the user; after the switch is released, the micro-controller module then operates the mouse as in the XY-axes direction. Therefore, in condition of no increase in assembling members and no requirement of using specific driving programs or programmable IC structures, the scrolling operation of the mouse can be controlled by applying the switch coupled with a conventional micro-controller of the mouse.

### BRIEF DESCRIPTION OF THE DRAWINGS

The invention can be more fully understood by reading the following detailed description of the preferred embodiments, with reference made to the accompanying drawings, wherein:

FIG. 1 is a block diagram showing the basic hardware structure of the controlling device for the mouse of the invention;

FIG. 2 is a block diagram showing the correlation between the controlling device for the mouse of the invention of FIG. 1 and a computer;

FIG. 3 is a circuit diagram showing part of internal elements of the controlling device for the mouse of FIG. 1 of the first preferred embodiment;

FIG. 4 is a circuit diagram showing part of internal elements of the controlling device for the mouse of FIG. 1 of the second preferred embodiment; and

FIG. 5 is a circuit diagram showing part of internal elements of the controlling device for the mouse of FIG. 1 of the third preferred embodiment.

FIG. 6 is a block diagram showing the basic hardware structure of the controlling device for the mouse of the fourth preferred embodiment.

### DETAILED DESCRIPTION OF THE PREFERRED EMBODIMENT

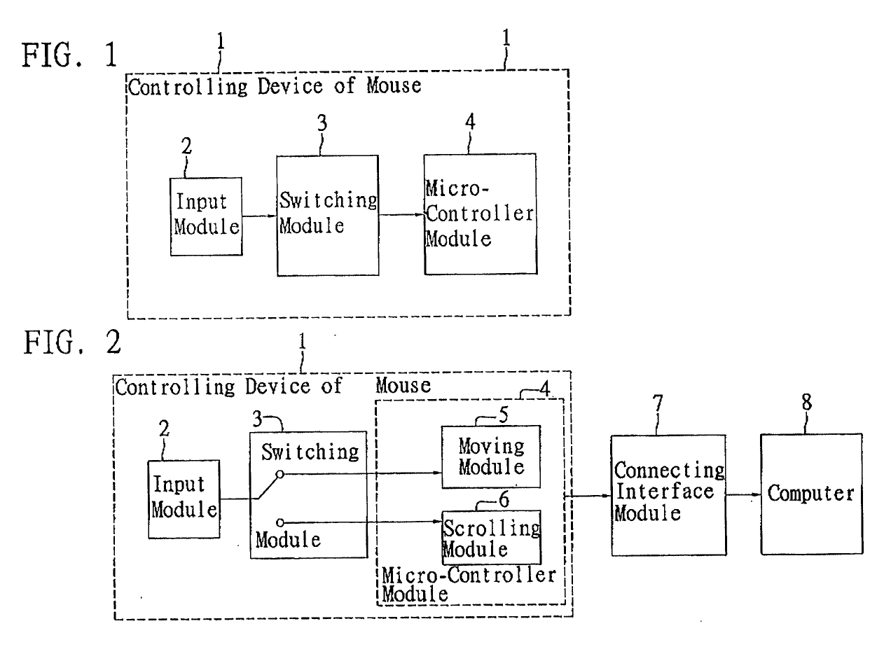

FIG. 1 illustrates the basic hardware structure of the controlling device for the mouse of the invention. As shown in the drawing, the controlling device 1 for the mouse includes an input module 2, a switching module 3 and a micro-controller module 4.

The input module 2 generates input signals by moving the mouse. The switching module 3 changed direction by pressing a switch (not shown) mounted in the mouse. The micro-controller module 4 receives the input signal from the switching module 3 and generates operating signals according to the input signals, whether the mouse to be scrolling upwardly or downwardly, or moving in the up-down or left-right direction. The switching module 3 switches the mouse to operate in the XY-axes direction or Z-axis direction, or alternatively switch the mouse to operate in the XY-axes direction or WZ-axes direction.

FIG. 2 is a block diagram illustrating the correlation between the controlling device of FIG. 1 and a computer. As shown in the drawing, the controlling device 1 for the mouse is connected to the computer 8. When the input module 2 is activated by moving the mouse, the input signal generated thereby is transmitted to the switching module 3 to produce the signal switching function, which is then transmitted to the micro-controller module 4. The micro-controller module 4 includes a moving module 5 for controlling the cursor to move in the up-down or left-right direction, and a scrolling module 6 for controlling the scrolling to scroll data shown on the screen upwardly or downwardly. Due to the switch being pressed in priority, the switching module 3 switches to the scrolling module 6, so that the cursor is controlled to operate in the Z-axis direction on WZ-axes direction. Then, the micro-controller module 4 is connected to the computer 8 by a connecting interface module 7. The interface module 7 is an input/output peripheral hardware device which might be integrated with the micro-controller module, and which transmits signals indicated by the micro-controller module 4 to the computer 8, so as to make the cursor simultaneously reacting as the operation of the mouse, e.g. moving the mouse upwardly makes the cursor move up or scroll the data upwardly.

First Preferred Embodiment

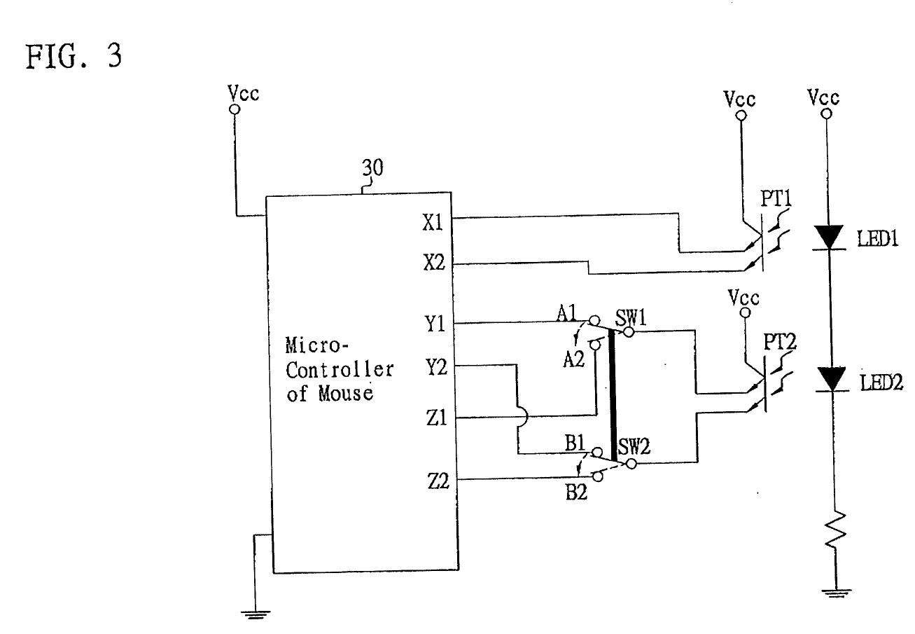

FIG. 3 is a circuit diagram showing part of internal elements of the controlling device for the mouse of FIG. 1 of the first preferred embodiment, wherein a double pole double gate switch is used, so as to switch the cursor to operating in the XY-axes direction or XZ-axes direction. A micro-controller 30 of the mouse, an integrated circuit (IC), is used to determine the operating state of the cursor to be moving in the up-down or left-right direction or scrolling upwardly or downwardly. As such, an output signal of the micro-controller 30 contains three pairs of parameters, including X1 and X2 controlling the left-right movement of the cursor, Y1 and Y2 controlling the up-down movement of the cursor, and Z1 and Z2 controlling the up-down scrolling of the cursor. The three pairs of parameters can be optionally connected or disconnected with optical decoders, and the phase difference in value between the two parameters of each pair can be read through the IC internal circuit, allowing to determine the current controlling state of the mouse. The optical decoders consist of photo-diodes and transistors, wherein wiring used for this connection depends on the type of the photo-transistor. A NPN type photo-transistor is applied to this preferred embodiment, so that the collector thereof is connected to a power supply. The optical decoders may alternative consist of image sensors, which digitally process image signals to generate controlling data.

First, the micro-controller 30 of the mouse has a first X-axis controlling signal X1 and a second X-axis controlling signal X2 connected to a first photo-transistor PT1. Then, a first Y-axis controlling signal Y1 is connected to a first gate A1 of a first switch SW1, which is connected with a second photo-transistor PT2; a second Y-axis controlling signal Y2 is connected to a first gate B1 of a second switch SW2, which is connected with the second photo-transistor PT2. Further, a first Z-axis controlling signal Z1 is connected to a second gate A2 of the first switch SW1 to be in an open state; a second Z-axis controlling signal Z2 is connected to a second gate B2 of the second switch SW2 to be in an open state. As a result, the current controlling state of the mouse is to operate in the XY-axes direction. In order to achieve the switching in operation between the XY-axes direction and the XZ-axes direction, the first and second switch SW1 and SW2 are to be pressed to close or open, so as to switch the cursor to operating in the XZ-axes direction for the up-down scrolling or in the XY-axes direction for the up-down or left-right movement.

The first switch SW1 and the second switch SW2 consist of a double pole double gate switch, and thus they simultaneously proceed the switching operation. As such, the first X-axis controlling signal X1 and the second X-axis controlling signal X2 are both connected with the first photo-transistor PT1. Further, the first Y-axis controlling signal Y1 is only connected with the first gate A1 of the first switch SW1 to be in an open state; the second Y-axis controlling signal Y2 is only connected with the first gate B1 of the second switch to be in an open state. Moreover, after the switching operation of the first switch SW1 and the second switch SW2 is proceeded, the first Z-axis controlling signal Z1 allows to be connected to the second gate A2 of the first switch SW1, which is connected with the second photo-transistor PT2; the second Z-axis controlling signal Z2 also allows to be connected to the second gate B2 of the second switch SW2, which is connected with the second photo-transistor PT2. As a result, the current controlling state of the mouse is to operate in the XZ-axes direction.

Second Preferred Embodiment

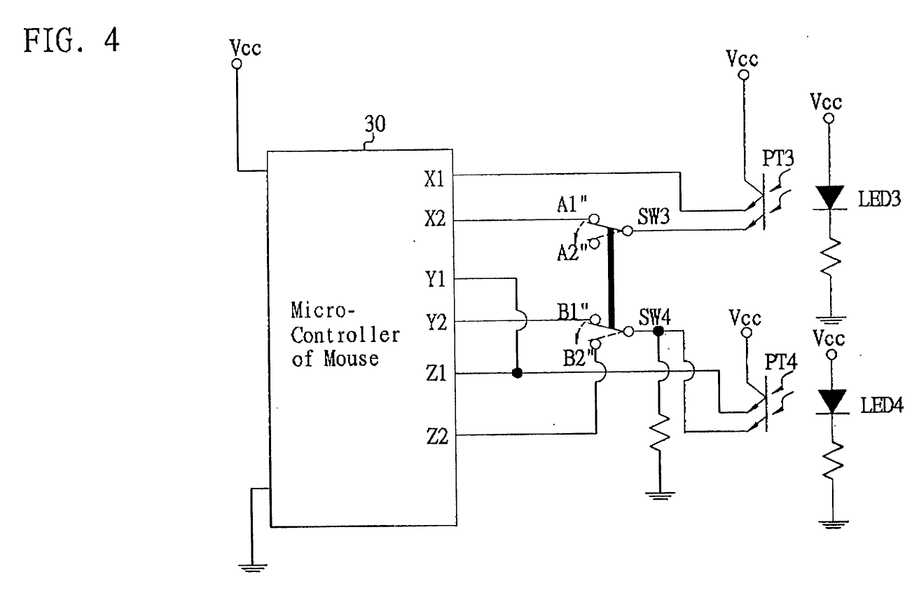

FIG. 4 is a circuit diagram showing part of internal elements of the controlling device for the mouse of FIG. 1 of the second preferred embodiment, wherein a double pole double gate switch is applied to switch to the operation in the XY-axes direction or the XZ-axes direction. As shown in the drawing, first, a micro-controller 30 of the mouse has a first X-axis controlling signal X1 connected to a first photo-transistor PT3, and a second X-axis controlling signal X2 connected to a first gate A1″ of a first witch SW3, which is connected with the first photo-transistor PT3. Then, a first Y-axis controlling signal Y1 is connected with a first Z-axis controlling signal Z1, both of which are connected to a second photo-transistor PT4; a second Y-axis controlling signal Y2 is connected to a first gate B1″ of a second switch SW4, which is connected to the second photo-transistor PT4. Further, a second Z-axis controlling signal Z2 is only connected with a second gate B2″ of the second switch SW4 to be in an open status. As a result, the current controlling state of the mouse is to operate in the XY direction.

The first switch SW3 and the second switch SW4 form a double pole double gate switch, and thus they proceed simultaneously the switching operation. As in open state, the first X-axis controlling signal X1, which is not connected with any of the switches, allows to be connected with the first photo-transistor PT3; the second X-axis controlling signal X2 allows to be only connected with the first gate A1″ of the first switch SW3 to be in an closed state. Further, the first Y-axis controlling signal Y1 and the first Z-axis controlling signal Z1, which are not connected to any of the switches, allow to be connected with the second photo-transistor PT4; the second Y-axis controlling signal Y2 is connected with the first gate B1″ of the second switch SW4 to be in an closed state which is connected to the second photo-transistor PT4. Moreover, the second Z-axis controlling signal Z2 is connected with the second gate B2″ of the second switch SW4 to be in an open state. After the first switch SW3 and second switch SW4 are closed, the second X-axis controlling signal X2 is in an open state, so that the phase difference between the X1 and X2 can not be determined by the micro-controller 30 of the mouse, and thus the X-axis direction is in a disable state. Similarly, if the second Y-axis controlling signal Y2 is in an open state, the phase difference between the Y1 and Y2 can not be obtained by the micro-controller 30 of the mouse, so that the Y-axis direction is in a disable state. However, the first Z-axis controlling signal Z1 and the second Z-axis controlling signal Z2 are both connected with the second photo-transistor PT4, allowing the micro-controller 30 of the mouse to determine the phase difference between the Z1 and Z2. As a result, the current controlling state of the mouse is switched to the Z-axis direction.

Third Preferred Embodiment

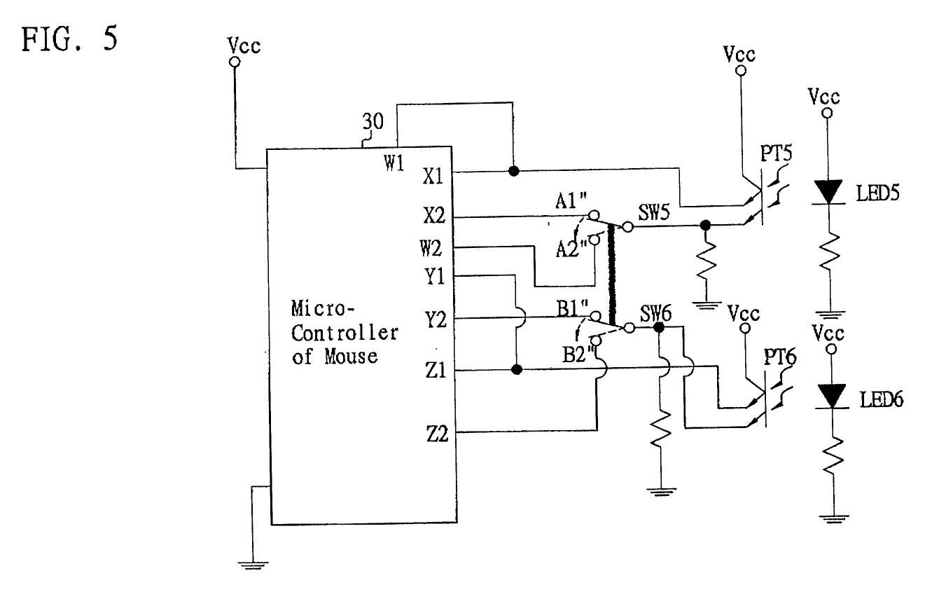

FIG. 5 is a circuit diagram showing part of internal elements of the controlling device for the mouse of FIG. 1 of the third preferred embodiment, wherein a double pole double gate switch is applied to switch to the operation in the XY-axes direction or the XZ-axes direction. As shown in the drawing, first, a micro-controller 30 of the mouse has a first X-axis controlling signal X1 connected with a first W-axis controlling signal W1, both of which are connected to a first photo-transistor PT5; and a second X-axis controlling signal X2 connected to a first gate A1″ of a first switch SW5, which is connected with the first photo-transistor PT5. A second W-axis controlling signal W2 is only connected with a second gate A2″ of the first switch SW5 to be in an open status. Then, a first Y-axis controlling signal Y1 is connected with a first Z-axis controlling signal Z1, both of which are connected to a second photo-transistor PT6; a second Y-axis controlling signal Y2 is connected to a first gate B1″ of a second switch SW6, which is connected to the second photo-transistor PT6. Further, a second Z-axis controlling signal Z2 is only connected with a second gate B2″ of the second switch SW6 to be in an open status. As a result, the current controlling state of the mouse is to operate in the XY direction.

The first switch SW5 and the second switch SW6 form a double pole double gate switch, and thus they proceed simultaneously the switching operation. As in open state, the first X-axis controlling signal X1, which is not connected with any of the switches, and the first W-axis controlling signal W1, which is also not connected with any of the switches, allows to be connected with the fist photo-transistor PT5; the second X-axis controlling signal X2 is connected with the first gate A1″ of the first switch SW5 to be in an closed state, which is connected to the first photo-transistor PT5. The second W-axis controlling signal W2 is connected with the second gate A2″ of the first switch SW5 to be in an open state. Further, the first Y-axis controlling signal Y1 and the first Z-axis controlling signal Z1, which are not connected to any of the switches, allow to be connected with the second photo-transistor PT6; the second Y-axis controlling signal Y2 is connected with the first gate B1″ of the second switch SW6 to be in an closed state, which is connected to the second photo-transistor PT6. Moreover, the second Z-axis controlling signal Z2 is connected with the second gate B2″ of the second switch SW6 to be in an open state. After the first switch SW5 and second switch SW6 are closed, the second X-axis controlling signal X2 is in an open state, so that the phase difference between the X1 and X2 can not be determined by the micro-controller 30 of the mouse, and thus the X-axis direction is in a disable state. Similarly, if the second Y-axis controlling signal Y2 is in an open state, the phase difference between the Y1 and Y2 can not be obtained by the micro-controller 30 of the mouse, so that the Y-axis direction is in a disable state. However, the first W-axis controlling signal W1 and the second W-axis controlling signal W2 are both connected with the first photo-transistor PT5, allowing the micro-controller 30 of the mouse to determine the phase difference between the W1 and W2. Moreover, the first Z-axis controlling signal Z1 and the second Z-axis controlling signal Z2 are both connected with the second photo-transistor PT6, allowing the micro-controller 30 of the mouse to determine the phase difference between the Z1 and Z2. As a result, the current controlling state of the mouse is switched to the WZ-axes direction. Where W-axis for scrolling in the left-right direction, and Z-axis for scrolling in the upward-downward direction.

Fourth Preferred Embodiment

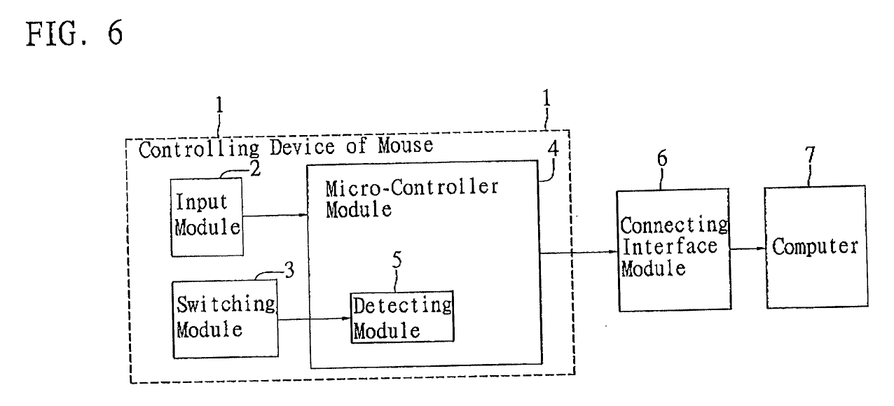

FIG. 6 illustrates the basic hardware structure of the controlling device for the mouse of the fourth embodiment. As shown in the drawing, the controlling device 1 for the mouse includes an input module 2, a switching module 3, a micro-controller module 4 which consists of a detecting module 5.

The switching module 3 receives outside signals by pressing a switch mounted in the mouse. The input module 2 generate input signals by moving the mouse. The detecting module 5 detects signals from the switching module 3, change its state of operation accordingly. The micro-controller module 4 then base on the state of operation to determine whether to operate on scrolling mode or on cursor-moving mode. As shown in the drawing, the controlling device 1 for the mouse is connected to the computer 7 through a connecting interface module 6. The interface module 6 is an input/output peripheral hardware device, which might be integrated with the micro-controller module 4, and which transmits signals indicated by the micro-controller module 4 to the computer 7, so as to make the cursor simultaneously reacting as the operation of the mouse, e.g. moving the mouse upwardly makes the cursor move up or scroll the data upwardly.

The second preferred embodiments differ from the first preferred embodiment in that the operating state of the cursor can be more stably controlled, that is, when an user manipulates the cursor to scroll data shown on the screen upwardly or downwardly, the cursor will not move in the left-right direction due to no detection for the movement in the X-axis direction being activated. The constructions of the first three preferred embodiments are interchangeable depends on functions needed.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A controller device for a mouse, said device comprising:
an input module for generating X-axis and Y-axis input signals; and
a switching module for receiving the input signals from the input module, and for switching the input signals to a micro-controller module including a moving module and a scrolling module.

2. The controlling device of claim 1, wherein
the input module uses an optical decoder as an input device;
the micro-controller module generates three pairs of controlling signals, which include a first and second X-axis controlling signals for controlling the movement of a cursor in a left-right direction, a first and second Y-axis controlling signals for controlling the movement of the cursor in an up-down direction, and a first and second Z-axis controlling signals controlling the scrolling in an up-down direction; and
the controlling signals are connected with the switching module; the switching module is composed of a plurality of electronic elements, which include a plurality of switches having a first gate and a second gate and a common gate, with the common gates of the switches connected with the optical decoders.

3. The controlling device of claim 2, wherein the plurality of switches are replaced by a switch set.

4. The controlling device of claim 2, wherein
the micro-controller module has the first and second X-axis controlling signals connected to a first optical decoder; the first and second Y-axis controlling signals are respectively connected to the first gates of a first and a second switches, which are connected with a second optical decoder;
the first and second Z-axis controlling signals are respectively connected to second gates of the first and second switches; and
as the first and second switches are switched, the second gates of the first and second switches are in connection with the optical decoders, and the first gates thereof are in open state, otherwise the second gates of the first and second switches are in open state, and the first gates thereof are in connection with the optical decoders.

5. The controlling device of claim 4, wherein the first and second switches are replaced by a switch set.

6. The controlling device of claim 2, wherein
the micro-controller module has the first X-axis controlling signal connected to the first optical decoder, and the second X-axis controlling signal connected to the first gate of the first switch, which is connected to the first optical decoder; the first Y-axis controlling signal and the first Z-axis controlling signal are interconnected, which are both connected to the second optical decoder;
the second Y-axis controlling signal is connected to the first gate of the second switch, which is connected with the second optical decoder; the second Z-axis controlling signal is connected to the second gate of the second switch; and
as the first and second switches are switched, the second gates of the first and second switches are in connection with the optical decoders, and the first gates thereof are in open state, otherwise the second gates of the first and second switches are in open state, and the first gates thereof are in connection with the optical decoders.

7. The controlling device of claim 6, wherein the first and second switches are replaced by a switch set.

8. The controlling device of claim 2, wherein the mouse is switched from operating in the XY-axes direction to the Z-axis direction after the switching module is switched.

9. The control device of claim 2, wherein the optical decoder is a digital image processor.

10. The controlling device of claim 6, wherein the mouse is switched from operating in the XY-axes direction to the Z-axes direction when the first and second switches changed direction.

11. The control device of claim 6, wherein the optical decoder is a digital image processor.

12. The controlling device of claim 1, wherein
the input module uses optical decoder as input device;
the micro-controller module includes four pairs of controlling signals, which comprise first and second X-axis controlling signals controlling the movement of a cursor in the left-right direction, first and second Y-axis controlling signals controlling the movement of the cursor in the up-down direction, and first and second W-axis controlling signals controlling the scrolling in the left-right direction, and first and second Z-axis controlling signals controlling the scrolling in the up-down direction;
the controlling signals are connected with the switching module; and
the switching module is composed of a plurality of electronic elements, which include a plurality of switches having a first gate and a second gate and a common gate, with the common gates of the switches connected with the optical decoders.

13. The controlling device of claim 12, wherein the plurality of switches are replaced by a switch set.

14. The controlling device of claim 12, wherein
the micro-controller module has the first X-axis controlling signal interconnected with the first W-axis controlling signal, which are both connected to the first optical decoder, and the second X-axis controlling signal connected to the first gate of the first switch, which is connected to the first optical decoder;
the second W-axis controlling signal is connected to the second gate of the first switch; the first Y-axis controlling signal and the first Z-axis controlling signal are interconnected, which are both connected to the second optical decoder, the second Y-axis controlling signal is connected to the first gate of the second switch, which is connected with the second optical decoder;
the second Z-axis controlling signal is connected to the second gate of the second switch; and
as the first and second switches of the input module are switched, the second gates of the first and second switches are in connection with the optical decoders, and the first gates thereof are in open state, otherwise the second gates of the first and second switches are in open state, and the first gates thereof are in connection with the optical decoders.

15. The controlling device of claims 14, wherein the first and second switches form a switch set.

16. The controlling device of claim 14, wherein the mouse is switched from operating in the XY-axes direction to the WZ-axes direction when the switching module is switched.

17. The controlling device of claim 14, wherein the optical decoder is a digital image processor.

18. A controller device for a mouse, said device comprising:
an input module for generating X-axis and Y-axis input signals;
a switching module for generating switching signals;
a detecting module for analyzing the switching signals, allowing to provide operating signals; and
a micro-controller module for analyzing the operating signals of the detecting module, switching to a moving module or a scrolling module accordingly.
